(19) United States
(12) Patent Application Publication
(10) Pub. No.: US 2012/0083270 A1
(43) Pub. Date: Apr. 5, 2012

(54) FEMTOCELL APPROVED USER LIST MANAGEMENT VIA SHORT MESSAGE SERVICE (SMS)

(75) Inventors: William Robbins, Sun Prairie, WI (US); Judson Flynn, Decatur, GA (US); Mark Ryan, Norcross, GA (US)

(73) Assignee: AT&T INTELLECTUAL PROPERTY I, L.P., Reno, NV (US)

(21) Appl. No.: 12/894,979

(22) Filed: Sep. 30, 2010

(51) Int. Cl. H04W 4/14; H04W 48/00

(52) U.S. Cl. 455/435.1; 455/466

(57) ABSTRACT

A system and methodology that facilitates user friendly and/or dynamic femtocell access provisioning based on Short Message Service (SMS) communication is provided. In particular, the system can enable users to update and/or view a femto access control list associated with a femtocell by employing SMS messages. Moreover, the system can receive a SMS message from a user equipment (UE) requesting an action (e.g., add, remove, and/or view an entry within a femto access control list) associated with femtocell access and identify a femtocell associated with the UE. Further, the system can analyze the SMS, request confirmation to perform the action, and execute the action on receiving confirmation from the UE.

### TECHNICAL FIELD

The subject disclosure relates to wireless communications and, more particularly, to a mechanism, that provides user-friendly and/or dynamic femtocell access provisioning based on Short Message Service (SMS) messaging.

### BACKGROUND

Femtocells—building-based wireless access points interfaced with a wired broadband network—are traditionally deployed to improve indoor wireless coverage, and to offload a mobility radio access network (RAN) operated by a wireless service provider. Improved indoor coverage includes stronger signal and improved reception (e.g., voice, sound, or data), ease of session or call initiation, and session or call retention as well. Offloading a RAN reduces operational and transport costs for the service provider since a lesser number of end users utilizes over-the-air radio resources (e.g., radio frequency channels), which are typically limited. With the rapid increase in utilization of communications networks and/or devices, mobile data communications have been continually evolving due to increasing requirements of workforce mobility, and, services provided by femtocells can be extended beyond indoor coverage enhancement; for example, femtocells can be utilized in areas wherein macro coverage is not poor or weak.

Conventional femtocells enable a user/owner to manage access to femtocell services by manually creating and/or updating access control list(s), or “white list(s).” Typically, such access control list(s), or white list(s) can be configured via a web interface, provided by a service provider, which facilitates management of access to a femtocell. The white list(s) includes a set of subscriber station(s) identifier numbers, codes or tokens, and can also include additional fields for femtocell access management based on desired complexity. Accordingly, by accessing the website (e.g., via a web browser) the user/owner can update and personalize a femto access point (FAP) autonomously (e.g., free of interaction with technical support entities) at substantially any time. However, management via a web interface limits the user/owner to update the access control list(s) only when an Internet connection is available.

In addition, the number of persons (e.g., friends and family) to which the user/owner can grant femtocell access is limited, and thus the user/owner has to frequently update the access control list(s) to ensure that the appropriate persons are granted access. Conventional systems enable the user/owner to update the access control list(s), only when connected to the Internet. Accordingly, the user/owner cannot modify the access control list(s) without access to a user equipment (UE) connected to the Internet. This can delay the update process (e.g., the user must wait until the user reaches home, office, a Wi-fi hotspot etc. and/or wait until the user has access to a UE with Internet connectivity) and lead to customer dissatisfaction.

### SUMMARY

The following presents a simplified summary of the specification in order to provide a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

The systems and methods disclosed herein, in one aspect thereof, facilitate dynamic management of femtocell network access by employing short message service (SMS) messages. In one aspect, the system includes a femto access management (FAM) component that can receive and analyze short message service (SMS) message(s) sent by a user over a macro and/or femto network, and can facilitate management of a femto access control list based on the analysis. In particular, the user can send a SMS message to a specific five-digit text messaging number associated with access control list management, from a user equipment (UE). In one example, the body of the SMS message can include text, such as, but not limited to, “Add XXX-XXX-XXXX” or “Remove XXX-XXX-XXXX”, wherein XXX-XXX-XXXX can be a unique device ID, code and/or token, representing the mobile number to be added or removed to/from the femto access control list.

In accordance with another aspect, the system includes a femtocell identification component that receives a request from a UE for performing an action (e.g., add/remove/view) associated with a femto access control list via a SMS message(s), and identifies a femtocell associated with the UE. Further, a confirmation component sends an auto-reply to the UE in response to the received SMS(s). The auto-reply requests the user to confirm the action specified in the SMS message(s). Furthermore, on receiving confirmation from the UE, via a SMS message, an update component performs the action requested by the UE (e.g., add/remove/view entry to/from the femto access control list).

Yet another aspect of the disclosed subject matter relates to a method that can be employed to facilitate dynamic provisioning of an access control list associated with a femto access point (FAP) by employing SMS communication. The method comprises receiving, from a UE, a request for femtocell access management within a first SMS message. Further, the method includes identifying a femtocell associated with the UE and requesting a confirmation (e.g., “To confirm the action to be performed on the femto access control list, reply “1” to this message.”) from the UE via a second SMS message. On receiving the confirmation, the action (e.g., add, remove, replace, view, etc.) requested in the first SMS can be performed.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example system that can dynamically provide and/or manage access to a femto network.

FIG. 2 illustrates an example system that can be employed for dynamically populating a femto access control list through Short Message Service (SMS) messages.

FIG. 3 illustrates an example system that utilizes SMS communication for femtocell access provisioning.

FIG. 4 illustrates an example system for restricting access to a femtocell by employing SMS messaging.

FIGS. 5A-C illustrate example screen shots of a graphical user interface (GUI) on a user equipment (UE), which facilitates dynamic femtocell access provisioning via SMS messaging.

FIG. 6 illustrates example screenshots that depict SMSs employed for femtocell access management.

FIG. 7 illustrates a series of example screenshots that depict utilization of SMS messages to view a femto access control list on a UE.

FIG. 8 illustrates example screenshots, which depict SMS messages employed to manage femtocell provisioning for multiple femtocells associated with a user account.

FIG. 9 illustrates example screenshots, which depict SMS messages delivered to a UE, indicative of an error during femtocell access management.

FIG. 10 illustrates an example methodology that can be utilized to facilitate dynamic provisioning of an access control list in a FAP by employing SMS communication.

FIG. 11 illustrates an example methodology that facilitates dynamically adding a device ID to a femto access control list by employing SMS messaging.

FIG. 12 illustrates an example methodology for employing SMS communication to remove a device ID from an access control list associated with a femtocell.

FIG. 13 illustrates an example wireless communication environment with associated components for operation of a femtocell in accordance with the subject specification.

FIG. 14 illustrates a schematic deployment of a macro cell and a femtocell for wireless coverage in accordance with aspects of the disclosure.

FIG. 15 illustrates a block diagram of a computer operable to execute the disclosed communication architecture.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details, e.g., without applying to any particular networked environment or standard. In other instances, well-known structures and devices are shown in block diagram form in order to facilitate describing the embodiments in additional detail.

As used in this application, the terms “component,” “module,” “system,” “interface,” “platform,” “service,” “framework,” or the like are generally intended to refer to a computer-related entity, either hardware, a combination of hardware and software, software, or software in execution or an entity related to an operational machine with one or more specific functionalities. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device or computer-readable storage/communications media. For example, computer readable storage media but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment,” “mobile station,” “mobile,” subscriber station,” “access terminal,” “terminal,” “handset,” “mobile device,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B (HNB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. Additionally, the terms “femtocell”, “MicroCell,” and “femto” are utilized interchangeably, while “macro cell” and “macro” are utilized interchangeably herein. Further, the terms “femto access control list,” “access control list,” “Approved User List,” “MicroCell Approved User list,” and the like are also utilized interchangeably herein.

Furthermore, the terms “user,” “subscriber,” “customer,” and the like are employed interchangeably throughout the subject specification, unless context warrants particular distinction(s) among the terms. Moreover, the terms “owner,” “authorized user,” and the like refer to an entity authorized to modify/update/create/delete/view femto access control list(s) associated with the femto access point (FAP). These terms are employed interchangeably throughout the subject disclose. It should be appreciated that the aforementioned terms can refer to human entities or automated components supported through artificial intelligence (e.g., a capacity to make inference based on complex mathematical formalisms), which can provide simulated vision, sound recognition and so forth.

Conventional systems enable a femtocell user to grant femtocell usage access to a limited number of persons (e.g., friends and family) by provisioning identity information in an access list within the core network and/or the femto access point (FAP). Typically, the length of the access list is limited (e.g., ten entries), and thus the user has to frequently update the access list to provide access to the appropriate persons. Traditional systems enable the user to access a web interface to update the access list. However, if the user does not have access to a web interface, the user cannot update the access list. The systems and methods disclosed herein provide user friendly, automatic, and dynamic femtocell access provisioning based on Short Message Service (SMS) messaging.

Aspects, features, or advantages of the subject innovation can be exploited in substantially any wireless communication technology; e.g., Wi-Fi, Worldwide Interoperability for Microwave Access (WiMAX), Enhanced General Packet Radio Service (Enhanced GPRS), Third Generation Partnership Project (3GPP) Long Term Evolution (LTE), Third Generation Partnership Project 2 (3GPP2) Ultra Mobile Broadband (UMB), High Speed Packet Access (HSPA), or Zigbee. Additionally, substantially all aspects of the subject innovation can be exploited in legacy telecommunication technologies.

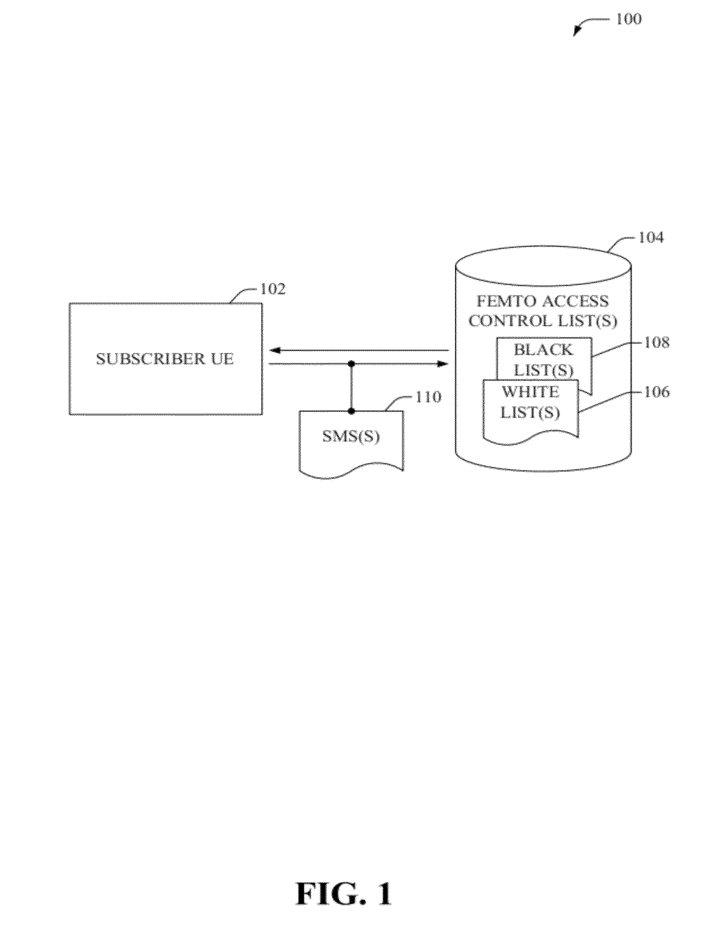

Referring initially to FIG. 1, there illustrated is an example system 100 that can dynamically provide and/or manage access to a femto network, according to an aspect of the subject innovation. In one aspect, system 100 enables a user equipment (UE) 102 to manage a femto access control list 104 via SMS messaging. Moreover, system 100 allows subscribers to add/remove entities within their access control list even when they do not have Internet access.

As an example, UE 102 as disclosed herein can include most any communication device employed by a subscriber, such as, but not limited to, a personal computer, a laptop, a cellular phone, a personal digital assistant (PDA), a media player, a gaming console, a digital camera, an IP television, an LTE (Long Term Evolution) based appliance, and the like. It can be appreciated that the UE can be mobile (e.g., media player), have limited mobility (e.g., desktop) and/or be stationary (e.g., LTE-based air conditioning unit). Further, the femto access control list(s) 104 can be stored in most any database, for example, within a femto access point (FAP) associated with the subscriber, or within the service provider's core network.

Functionality provided by example system 100 to authorize, permanently or temporarily, or deny or revoke access to specific subscribers, or subscriber station(s), comprise what is herein termed as an femto access control list(s) 104 (e.g., white list(s) 106 or black list(s) 108)—an instrument for management of access to femto cell coverage. Additionally, in connection with authorization for access to femto cell coverage, example system 100 facilitates generation/update of a white list profile (not shown) which includes parameters that control, or facilitate access logic to, femto cell coverage as provided (e.g., granted or denied) through femto access control list(s) 104 (e.g., white list(s) 106 or black list(s) 108). In one example, the femto access control list(s) 104 (e.g., white list(s) 106 or black list(s) 108) can be, but are not limited to, relational database tables that include a set of one or more fields for each attribute in the tables. It is noted, however, that other table models (e.g., hierarchical, object oriented) can be employed to define the femto access control list(s) 104. Various attributes can be defined for access list(s); for example, communication device identifier attribute, which uniquely identifies the communication device; public or private attribute, which can be an election flag (e.g., opt-in/opt-out flag) that establishes whether communication device identifier can be shared among disparate access list(s); device technology attribute(s), which provides information on operation capabilities of communication device(s) includes within white list(s); and so forth.

As an illustration, a device identifier attribute in a femto access control list(s) 104 (e.g., white list(s) 106 or black list(s) 108) can support up to N fields (wherein, N a positive integer; e.g., N=50) for unique mobile phone numbers (e.g., MSIDSNs, IMSIs), or any suitable codes (e.g., electronic serial numbers (ESNs), SIM credentials) or tokens that identify a communication device. Number N of fields can be determined, or configured, by a service operator based at least in part on technical aspects (like network resources, quality of service consideration, macro area of coverage (e.g., metropolitan statistical area (MSA), or rural service area (RSA)) and commercial aspects (such as promotional considerations, mitigation of customer attrition, gains in market share, etc.) of provision of coverage. As an example, N can be subscriber dependent or FAP dependent; e.g., premium subscriber that consumes substantive volume of data, like prosumers, can have larger N than subscribers that primarily consume voice. It should be appreciated that the magnitude of N can also be determined dynamically, and augmented on a subscriber-need basis within bounds determined by network capacity.

In an aspect of the subject innovation, black list(s) 108 can include a single attribute field, which uniquely identifies a communication device; the identified device is denied femto access service. It is noted that while a black list 108 is a realization of an access list, and can be configured by a consumer according to aspects described herein, a black list can be employed as an administrative instrument to deny femto service under various criteria, e.g., lack of payment for service(s), unlawful utilization of a provisioned femto access point, and so forth. In one example, devices identified in a black list can operate in “emergency call” mode only.

According to an embodiment, access field(s) associated with the femto access control list(s) 104 (e.g., white list(s) 106 or black list(s) 108) attribute(s) can be populated with content(s) can be specified at most any time, by a user employing subscriber UE 102. In particular, the access field(s) can be embodied in a short message service (SMS) communication 110. In another example, the access field(s) can be also be embodied within a multimedia service (MMS) communication, an email communication, instant message (IM) communication, an unstructured supplementary service data (USSD) message, or the like. Access field indication(s) can be processed by a server (e.g., Short Message Service Center (SMSC)) that can provide the various services (e.g., SMS) that facilitate the embodiments of access field indication(s).

In one aspect, an authorized user (e.g., femtocell owner) can compose a SMS message 110 via UE 102. Moreover, the text included within the SMS 110 can specify modification of the femto access control list(s) 104. For example, the body of the SMS message can be, but is not limited to, “Add XXX-XXX-XXXX” or “Remove XXX-XXX-XXXX” (where XXX-XXX-XXXX can be most any mobile number/device identifier (ID), code and/or token, to be added or removed to/from the access control list(s) 104). Typically, the syntax for the text within the SMS 110 can be specified by the service provider. Further, the user can send the SMS message 110 to a special five-digit Approved User List Management text messaging number, for example, set by the service provider, to facilitate management of the access control list(s) 104.

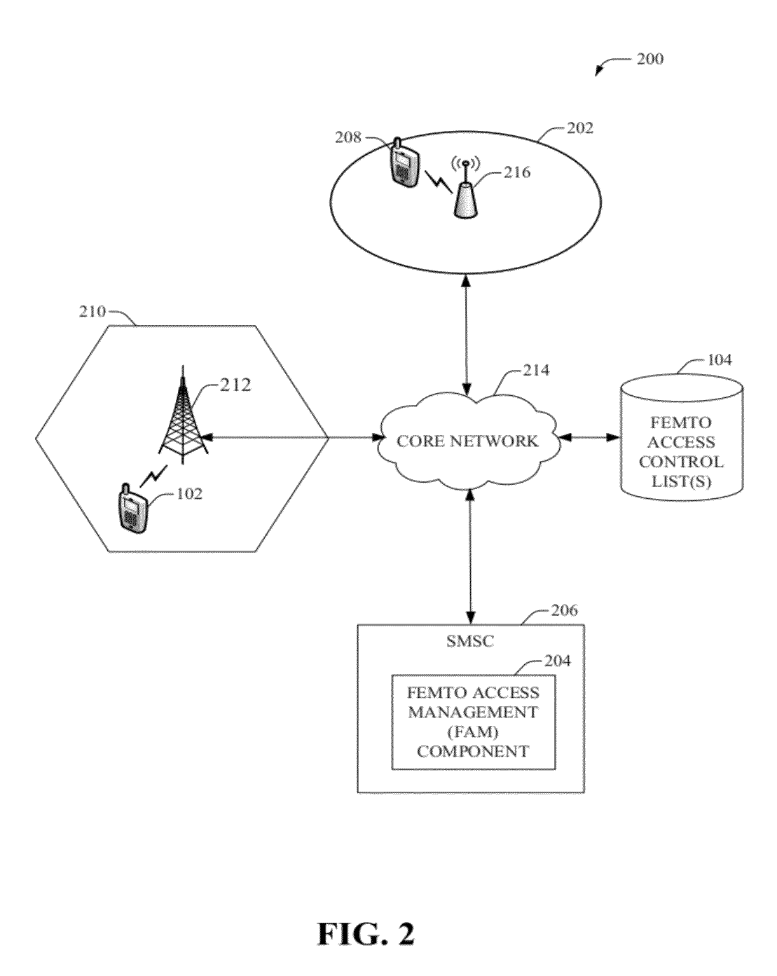

Referring to FIG. 2, there illustrated is an example system 200 that can be employed for dynamically populating a femto access control list 104 in accordance with an aspect of the subject disclosure. Moreover, system 200 facilitates management of access to a femtocell 202 through SMS messaging. Typically, femtocell 202 can be deployed in most any location, such as, but not limited to a home, hotel, office, restaurant, warehouse, salon, hospital, factory, apartment complex, airport, health club, etc. It can be appreciated that the UE 102 and femto access control list 104 can include functionality, as more fully described herein, for example, with regard to system 100.

In one aspect, the system 200 includes a femto access management (FAM) component 204 that can reside within a SMSC 206, and/or be operatively connected to the SMSC 206. The FAM component 204 can receive SMS messages from a UE, for example, UE 102 and/or UE 208, directed to a specific number, extract information from the SMS(s) and apply modifications to the femto access control list(s) 104 based on an analysis of the extracted information. Moreover, the system 200 enables users to update and/or modify access control settings of their femtocell (e.g., femtocell 202) from most any location with mobile connectivity. In one aspect, UE 102 can be located within macro cell 210 served by base station 212. A SMS message can be created on the UE, for example, employing a syntax specified by the service provider, and the SMS can be transmitted by the UE to a specific number, for example, a five-digit Approved User List Management text messaging number, via the macro network. Moreover, the SMS is initially forwarded to a network element in the core network 214, such as, but not limited to, the SMSC 206, which facilitates delivery of SMS messages.

According to an embodiment, the SMSC 206 can forward SMS(s) directed to the specific number, to the FAM component 204 for further handling. The FAM component 204 can identify a femtocell (e.g., femtocell 202), to which access changes are to be applied, based on the UE 102 (or user) from which the SMS is received and/or the contents of the SMS. In an aspect, the FAM component 204 can analyze the contents of the SMS and accordingly update, modify, change, delete, create, etc., the femto access control list(s) 104 based on the analysis. It can be appreciated that the femto access control list(s) 104 can be located within the core network and/or can reside within a femto access point (FAP) 216 of the femtocell. In another example, UE 208, connected to the FAP 216 can also be employed for femtocell access management. In one aspect, a SMS providing changes to be made to the femto access control list(s) 104 can be transmitted by the UE 208 to the SMSC 206 via the femto network. The FAM component 204 can intercept the SMS, analyze the contents of the SMS and accordingly update and/or modify the entries in the femto access control list 104.

It can be appreciated that the femto access control list 104 can include volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data stores, databases) of the subject systems and methods is intended to comprise, without being limited to, these and any other suitable types of memory.

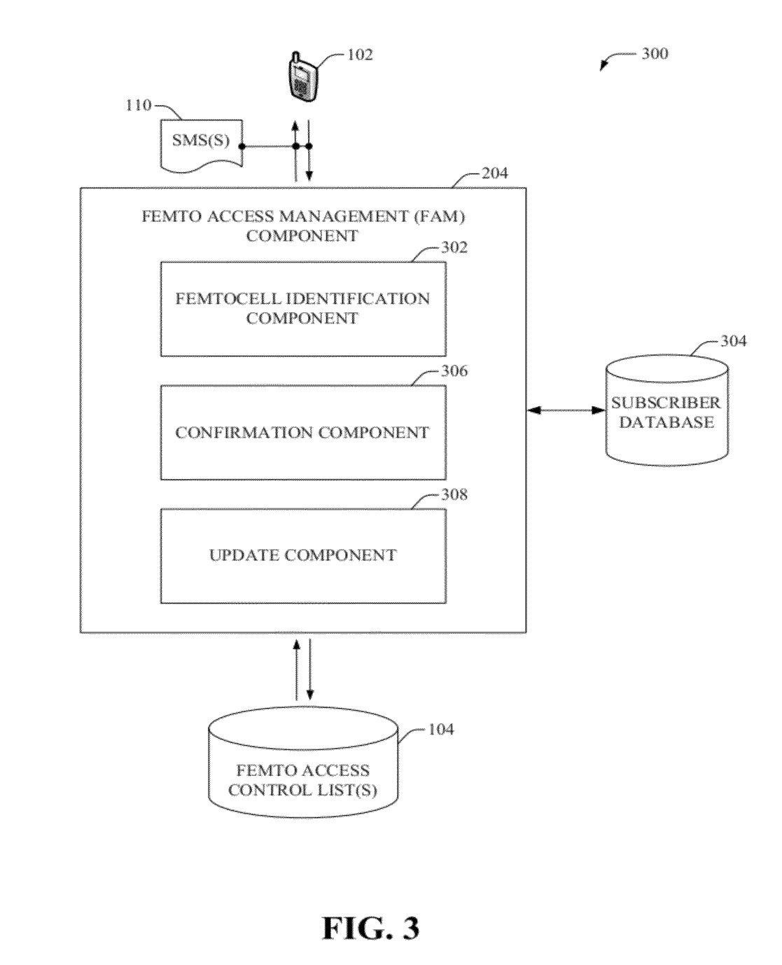

Referring now to FIG. 3, there illustrated is an example system 300 that utilizes SMS communication for femtocell access provisioning. Typically, UE 102 can transmit SMS message(s) 110 to a specific number, provided for femto access management, over the mobile network (e.g., femto and/or macro network). In one aspect, all SMS message (s) directed to the specific number can be handled by the FAM component 204, which can reside within a SMSC and/or at most any location in the core network. As an example, the specific number can be a five-digit number specified by the service provider. It can be appreciated that the UE 102, femto access control list 104, and FAM component 204 can include functionality, as more fully described herein, for example, with regard to system 100 and 200.

According to an aspect, the FAM component 204 can include a femtocell identification component 302. The femtocell identification component 302 can receive the SMS message(s) 110, directed to the specific number and identify a femtocell associated with the SMS message(s) 110. For example, the femtocell identification component 302 can determine a femtocell based on various factors, such as, but not limited to, the UE 102, information retrieved from a subscriber database 304, information within the SMS(s), explicitly querying the UE 102 (e.g., via SMS messages) for femtocell identification information, etc. Typically, the subscriber database 304 can store account records associated with various users/UEs, including information related to femtocells and/or femto access lists registered with the records. In one aspect, the femtocell identification component 302 can look-up the subscriber database 304 and retrieve information related to an account associated with the user/UE 102. The information can include data associated with one or more femtocell registered to the user/UE 102.

Further, a confirmation component 306 can be employed to send an auto-reply to the UE 102 in response to the received SMS(s) 110. The auto-reply can include a message requesting the user to confirm execution of the action specified in the SMS(s) 110. In addition, the confirmation component 306 can also send error messages, status messages, and/or verification messages to the UE 102 via SMS communication. Furthermore, on receiving confirmation from the UE 102 (e.g., by the confirmation component 306), an update component 308 can execute the action requested in the SMS(s) 110. For example, the update component can update, delete, create and/or modify entries in the femto access control list(s) 104 based on the text within the SMS(s) 110. In addition, if the user requests to view the current femto access control list 104, the update component can provide the current femto access control list to the UE 102 through one or more SMS messages.

As an example, a user (e.g., authorized user and/or femtocell owner) can send a text message (e.g., SMS) to a network provider specified five-digit text messaging number by employing UE 102. The body of the text message can include instructions, in most any pre-defined syntax, for adding and/or removing entries from the femto access control list(s) 104. For example, the SMS(s) 110 can include “Add XXX-XXX-XXXX” and/or “Remove XXX-XXX-XXXX,” wherein XXX-XXX-XXXX can represent a device ID (e.g., MSISDNs, IMSIs, etc.), token and/or code representing the UE to be added and/or removed to/from the femto access control list(s) 104. In an example scenario wherein the user sends a SMS message 110, via UE 102 to add a device ID to the list 104, the FAM component 204 can receive the SMS 110 and look-up the sender's account (e.g., by employing subscriber database 304) to identify a femtocell associated with the UE 102. In one aspect, the confirmation component 306 can send a SMS message to the UE 102 requesting confirmation for adding the entry to the femto access control list 104 associated with the identified femtocell. On receiving confirmation from the UE 102, via a SMS message, the update component 308 can add the requested entry into the femto access control list 104. In the example wherein the femtocell cannot be identified, the confirmation component 306 can transmit a SMS message to the UE 102 indicative of an error. Further, if the confirmation component 306 can determines that all entries in the femto access control list 104 are currently occupied, the confirmation component 306 can transmit a SMS message to the UE 102 indicating that the list is full, requesting that one or more entries be removed, and/or querying for an entry to be replaced.

In another example scenario wherein the user sends a SMS message 110, via UE 102 to remove a device ID from the femto access control list 104, the FAM component 204 can receive the SMS 110 and look-up the sender's account (e.g., by employing subscriber database 304) to identify a femtocell associated with the UE 102. The confirmation component 306 can send the UE 102 at least one of the following SMS messages: (i) a message requesting confirmation to remove the entry from the femto access control list 104; (ii) an error message, if a femtocell associated with the user's account is not found; (iii) an error message, if the requested number is not in the femto access control list 104, etc. Typically, when errors are not found, and confirmation is received from the UE 102, the update component 308 can remove the requested entry from the femto access control list 104. Additionally, the confirmation component 306 can transmit a SMS message to the UE 102 indicating a successful update of the femto access control list 104.

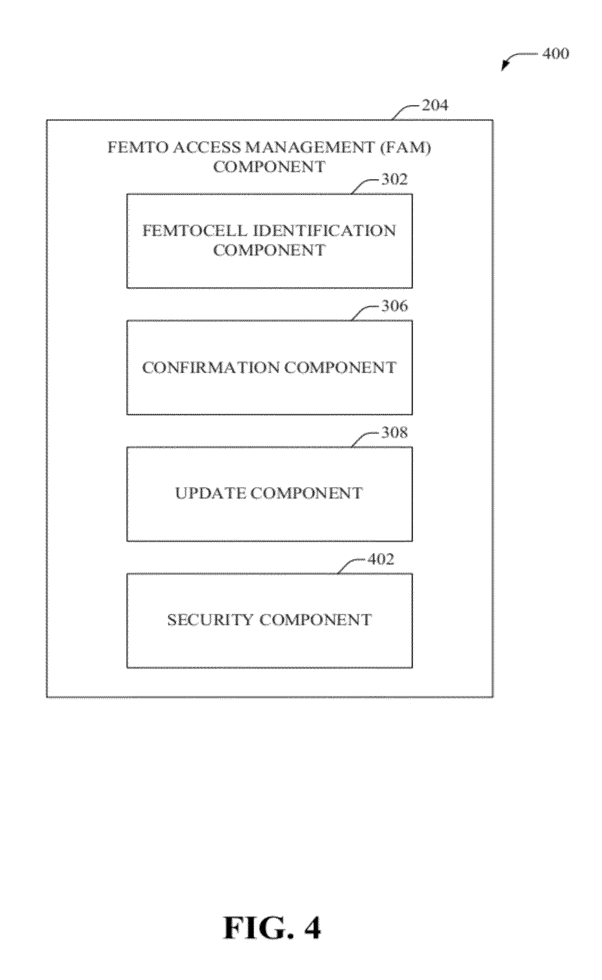

FIG. 4 illustrates an example system 400 for restricting access to a femtocell by employing SMS messaging, according to an aspect of the subject specification. It can be appreciated that the FAM component 204, femtocell identification component 302, confirmation component 306 and update component 308 can include functionality, as more fully described herein, for example, with regard to system 100, 200, and 300. In one aspect, users can send SMS messages to remove and/or add entries from their femtocell access control lists. The SMS messages can be routed to the FAM component 204, which can facilitate updates to the femtocell access control lists.

In one aspect, the FAM component 204 can include a security component 402 that can be employed to authenticate the user/UE. As an example, the security component 402 can determine whether the UE, from which the SMS message is received, is authorized to update the femtocell (e.g., identified by the femtocell identification component 302) and/or access a femto access control list of the femtocell. Moreover, the security component 402 can compare the UE's ID (e.g., MSISDNs, IMSIs, etc.) with a set of authorized UE IDs (e.g., stored in a subscriber database) associated with the femtocell, to identify whether the UE is authorized to modify the femto access control list. In another example, the security component 402 can transmit a SMS message to the UE requesting a password to authenticate the user. Accordingly, the security component 402 can prevent access by an unauthorized entity employing an authorized device and/or facilitate access by an authorized user from an unauthorized device. Moreover, the security component 402 can request and/or receive a password from the UE (e.g., in a SMS message) and can verify whether the user is authorized to access the femto access control list based on the password. It can be appreciated that security component 402 can utilize most any identification, verification, and/or authentication mechanism(s) to prevent unauthorized access. If the security component 402 cannot authenticate a user/UE, the confirmation component 306 can deliver a SMS message to the UE indicating that the user/UE is not authorized to access the femto access control list.

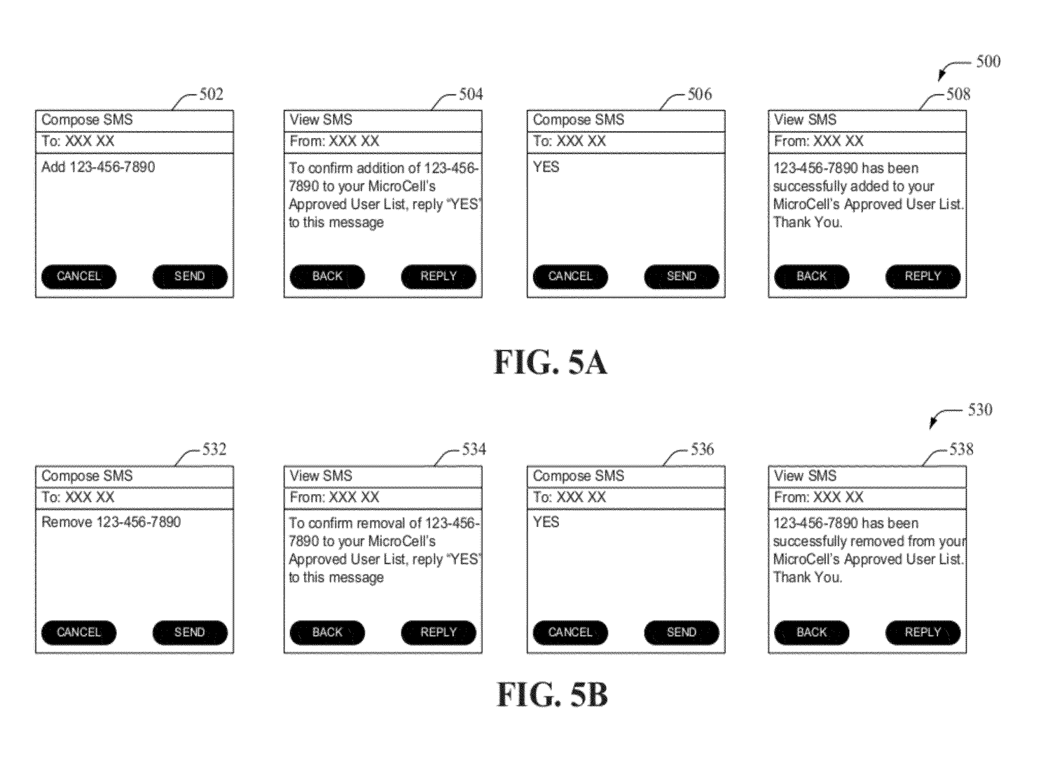

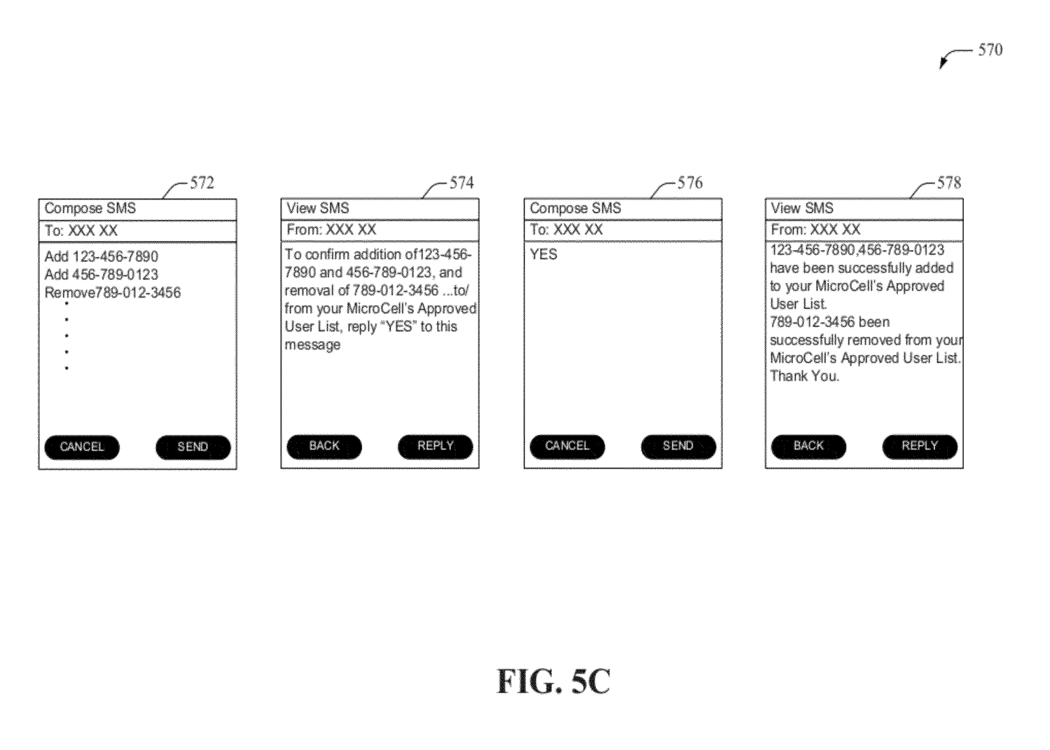

Referring to FIGS. 5A-C, there illustrated are example screen shots (500, 530, 570) of graphical user interfaces (GUIs) on a UE, which facilitate dynamic femtocell access provisioning via SMS messages, in accordance with an aspect of the subject disclosure. Typically, the GUIs can include a plurality of related images and interface objects or elements to facilitate user manipulations to the various functions within a UE (e.g., UE 102). For example, an interface can include any combination of, among other things, text, text boxes, drop down menus, checkboxes, and buttons which can be interacted with utilizing one or more of a pointing device (e.g., stylus, mouse, trackball, touchpad, touch screen, etc.), keyword, or voice activated software.

In one embodiment, the UE can manage femto access control through SMS messaging. Typically, the UE as disclosed herein can include most any communication device employed by a user, such as, but not limited to, a personal computer, a laptop, a cellular phone, a personal digital assistant (PDA), a media player, a gaming console, LTE-device, and the like. The GUIs in FIGS. 5A-C depict a series of example screenshots (500, 530, 570) that enable a user to input and/or receive femtocell provisioning information embodied in a short message service (SMS) communication. It can be appreciated that user input can also be embodied within a multimedia service (MMS) communication, an email communication, instant message (IM) communication, an unstructured supplementary service data (USSD) message, or the like.

Referring now to FIG. 5A, there illustrated is a series of screen shots 500 related to SMS communication displayed on a GUI of the UE, during addition of an entry to the user's femto access control list. In one aspect, at 502, the user can compose a SMS, for example, utilizing most any SMS application on the UE, with most any syntax specified by the service provider. For example, to add an entry to the femto access control list, the user can type “ADD<space><entry ID>” in the SMS message. Moreover, the entry ID can be a number, token and/or code (e.g., MSISDN, IMSI, etc.) that identifies the device to be added to the femto access control list. At 502, an example device ID, 123-456-7890 is to be added to the user's femto access control list. Accordingly, the user can compose a SMS message with “ADD 123-456-7890” contained within the body of the message. In one example, the SMS message can be sent to a number specified by the service provider for femtocell management. For example, the number can be most any five-digit number (e.g., XXX-XX). On sending the SMS message (e.g., pressing/clicking/selecting the send button in interface 502), the SMS message is directed to the FAM component 204. In one aspect, the femtocell identification component 302 can determine a femtocell associated with the UE. In another aspect, the user can provide a femtocell ID and/or password in message 502 (not shown), to facilitate identification of the femtocell. Further, confirmation component 306 can generate and send an auto-reply to the UE in response to the received SMS message. In particular, 504 depicts the auto-reply, viewed on the UE's GUI. Moreover, the auto-reply, can request confirmation from the user to add the requested entry to the femto access control list. As an example, the auto-reply can include a message, such as, but not limited to, “to confirm addition of 123-456-7890 to your MicroCell's Approved User List, reply ‘YES’ to this message.” It can be appreciated that the confirmation message illustrated in 504 is simply one example, and most any other confirmation message can be employed. For example, the user can be requested to send a password or most any other text (e.g., “add”, “1”, etc.) in a reply SMS message, as confirmation. At 506, the user can respond to the auto-reply, and send a confirmation SMS message, as requested by the confirmation component 306. Moreover, on receiving the SMS message, the update component 308, can add the requested entry (e.g., 123-456-7890) to the identified femto access control list. Further, the confirmation component 306 can transmit a SMS message indicative of a successful addition. Example screenshot 508 depicts the SMS message displayed on the UE's GUI.

FIG. 5B illustrates a series of screenshots 530 of example SMS communication on a GUI, to remove an entry from the user's femto access control list. Screenshot 532 illustrates a SMS message composed in most any SMS application on the UE, for example, by employing most any syntax specified by the service provider. Typically, to remove an entry from the femto access control list, the user can type, “REMOVE<space><entry ID>” in the SMS message. As an example, the entry ID can be a number, token and/or code (e.g., MSISDN, IMSI, etc.) that identifies a communication device to be removed from the femto access control list. Interface 532 depicts a SMS message indicating an example device ID, 123-456-7890, to be removed from the user's femto access control list. In one aspect, the SMS message can be sent to a number specified by service provider for femtocell management, for example, a predefined five-digit number (e.g., XXX-XX). The SMS is received by the FAM component 204 and a femtocell associated with the sender (e.g., UE, user, etc.) can be determined by the femtocell identification component 302. Additionally or optionally, a femtocell ID and/or password can be provided in 532 (not shown), to facilitate identification of the femtocell. Further, the confirmation component 306 can generate and send an auto-reply to the UE in response to the received SMS. In particular, 534 depicts the auto-reply, viewed on the UE interface. Moreover, the auto-reply, can request confirmation from the user to remove the requested entry from the femto access control list. As an example, the auto-reply can include a message, such as, but not limited to, “to confirm removal of 123-456-7890 to your MicroCell's Approved User List, reply ‘YES’ to this message.” It can be appreciated that the subject innovation is not limited to the confirmation message illustrated in 534, and most any other confirmation message can be employed. For example, the user can be requested to reply with a password or most any other text (e.g., “remove”, “1”, etc.) as confirmation. Screen shot 506 of the GUI on the UE, illustrates a SMS message composed in response to the auto-reply, which can be sent back to the FAM component 204 (e.g., directed to the specified five-digit number). Moreover, on receiving the SMS message, the update component 308, can remove the requested entry (e.g., 123-456-7890) from the identified femto access control list. In addition, the UE can receive a SMS message from the confirmation component 306 indicative of a successful removal of the requested entity, as depicted by screenshot 508.

FIG. 5C depicts a series 570 of screenshots relating to femtocell access management via SMS messages. In one aspect, the user can include multiple entries to be added and/or removed to/from the femto access control list, within one SMS message, as depicted at 572. Specifically, the multiple entries can be separated with the return key (enter), semicolons, commas, etc. Although, only three entries are listed in 572, it can be appreciated that the subject specification is not so limited and most any number of entries can be specified within the message. In one aspect, the SMS message illustrated in 572, can be directed to the FAM component 204 by transmitting the SMS message to a number, for example, a predefined five-digit number (e.g., XXX-XX), specified by service provider for femtocell management. The SMS message can be delivered to the FAM component 204 and a femtocell associated with the sender (e.g., UE, user, etc.) can be determined by the femtocell identification component 302. Further, the confirmation component 306 can generate and transmit an auto-reply to the UE in response to the received SMS message. The user can view the auto-reply at 374, and can respond to the auto-reply by sending a confirmation SMS message as shown at 376. The confirmation is received by the update component 308, which can modify the appropriate femto access control list based on the request within the SMS message. Moreover, if modification is successful, the confirmation component 306 can deliver a SMS message to the UE indicative of the completion of the update, which can be viewed on the UE's GUI as shown at 578.

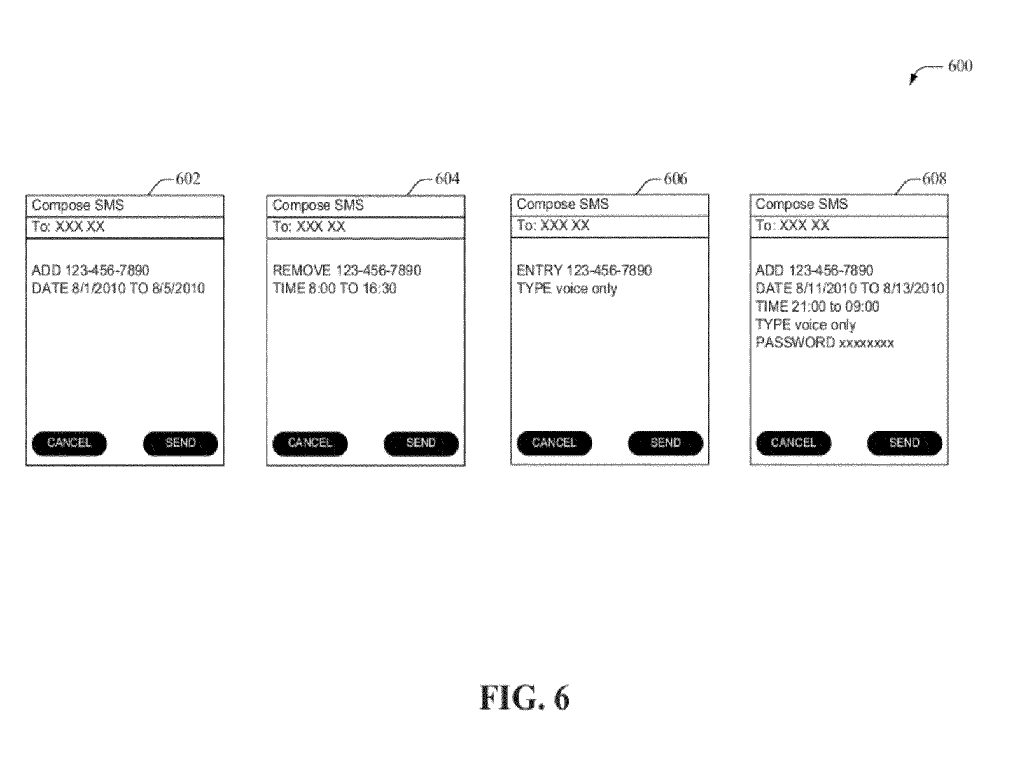

FIG. 6 illustrates example screenshots 600 that depict SMS messages employed for femtocell access management, according to an aspect of the subject innovation. Screenshots 600 can be displayed on at least a portion of a GUI (e.g., monitor, touch screen, LCD display, etc.) associated with the UE. According to an embodiment, the subject system enables a user to specify additional parameters, for example, access policies, user preferences, etc., associated with femtocell access, via SMS messaging. For example, the additional parameters can include, but are not limited to, (i) a category of service (e.g., voice only, data only, voice and data), or a class of service, which determines access to specific applications or services such as scheduler, calendar(s), news streaming, authoring tools, gaming, video and music, etc., that is allowed for an entry in the femto access control list; (ii) quality of service configuration, or customization, for device access to femto coverage, such as guaranteed QoS (e.g., guaranteed packet rate, or guaranteed block error rate) rather than best effort delivery; (iii) time span of allowed service for the communication device such as, but not limited to, temporary full access to provisioned femto service(s), e.g., full access for a specific time interval such as days (e.g., a relative is on vacation on a house with a provisioned FAP) or hours (e.g., babysitter is on duty), and/or temporary restricted access, which can determine access to selected services only within a window of time in a day (e.g., voice and data allowed from 9:00a-6:00p, or voice allowed after 9:00p which can facilitate billing schemes already established by an operator/service provider); (iv) telecommunication technology allowed for use in a femto cell when the communication device supports operation through multiple technologies (e.g., GSM, 3GPP UMTS, 3GPP LTE Advanced . . . ); (v) billing aspects for an identified communication device; (vi) a priority associated with the entry; and so on.

As seen from screen shots 602-608, various parameters can be specified along with the request to add/remove an entry from the femto control access list. Typically, the syntax for the additional parameters can be predefined by the service provider. In one example, a user can specify a time period in days (e.g., Aug. 1, 2010 to Aug. 5, 2010) during which the entry can be added to (or removed from) the femto access control list, as shown at 602. Accordingly, the update component 308 can add the requested entry (e.g., 123-456-7890) to the user's femto access control list on Aug. 1, 2010, and remove the requested entry from the list on Aug. 5, 2010. Similarly, the user can define a time period in hours (e.g., 8:00 to 16:30) during which the entry (e.g., 123-456-7890) can be removed from (or added to) the femto access control list, as shown at 604. On receiving the SMS message depicted in 604, the update component 308 can remove the requested entry from the femto access control list during the specified hours.

Further, the user can also restrict the type of communication services granted/denied to an entry within the femto access list. It can be appreciated that the additional parameters can be set when the entry is added/removed to/from the femto access control list (e.g., as shown at 602, 604), or at most any other time, by specifying the entry ID (e.g., MSISDN, IMSI, etc.), whose parameters are to be set, in the SMS message (e.g., as shown at 606). In one example, syntax (e.g., ENTRY <space> ALL) can be defined to apply the parameters to all entries in the femto access control list. Referring back to 606, the example screenshot depicts a SMS message composed on a UE to restrict communication services to voice communication for a requested entry (e.g., 123-456-7890). Further, a plurality of parameters associated with one, multiple or all entries in the femto access control list can be specified within a SMS message. For example, as shown in screen shot 608, an entry (e.g., 123-456-7890) can be added to the femto access control list (e.g., by the update component 308) to provide voice communication between 21:00 to 9:00, during Aug. 11, 2010 to Aug. 13, 2010. Additionally or optionally, a password can also be provided in the SMS message, which can be employed by security component 402 to facilitate authentication of the user/UE.

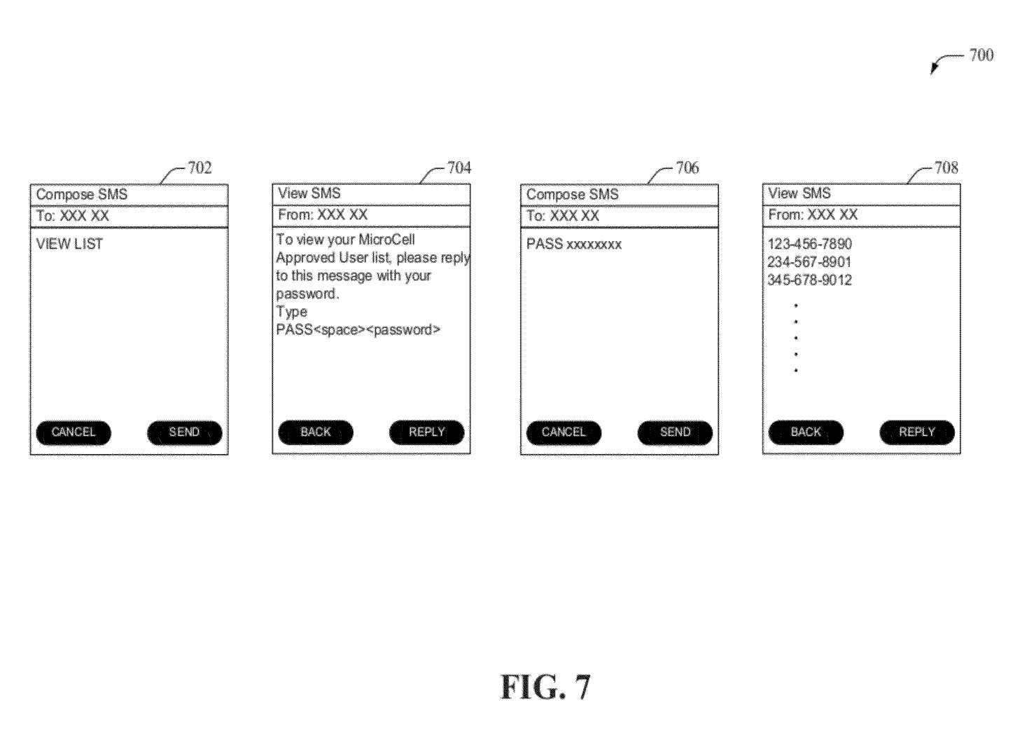

Referring now to FIG. 7, there illustrated are a series of example screenshots 700, that depict utilization of SMS messages to view a femto access control list on a UE connected to a macro and/or femto network. Typically, the user can transmit a SMS message to a number (e.g., specific five-digit number) associated with femtocell management, requesting to view the femto access control list. In particular, the user can employ most any pre-defined syntax to compose the SMS, for example, the user can type “VIEW LIST” as shown at 702. According to an aspect, the SMS is received by the FAM component 204, which detects the femtocell and/or femtocell access list associated with the user/UE (e.g., by employing femtocell identification component 302) and generates an auto-reply SMS message (e.g., by employing confirmation component 306), which requests a confirmation from the user. The UE receives the auto-reply, which can be displayed to the user, as shown at 704. In one example, a password can be requested in response to the auto-reply (e.g., by the confirmation component 306). The user can enter the password, for example, by employing example syntax “PASS<space><‘password’>”, as shown in 706. Moreover, on receiving the password, a security component 402 can authenticate the user and an update component 308 can transmit the current femto access control list to the UE via one or more SMS messages, if authentication is successful. Accordingly, the SMS message comprising the list can be displayed to the user, as shown at 708.

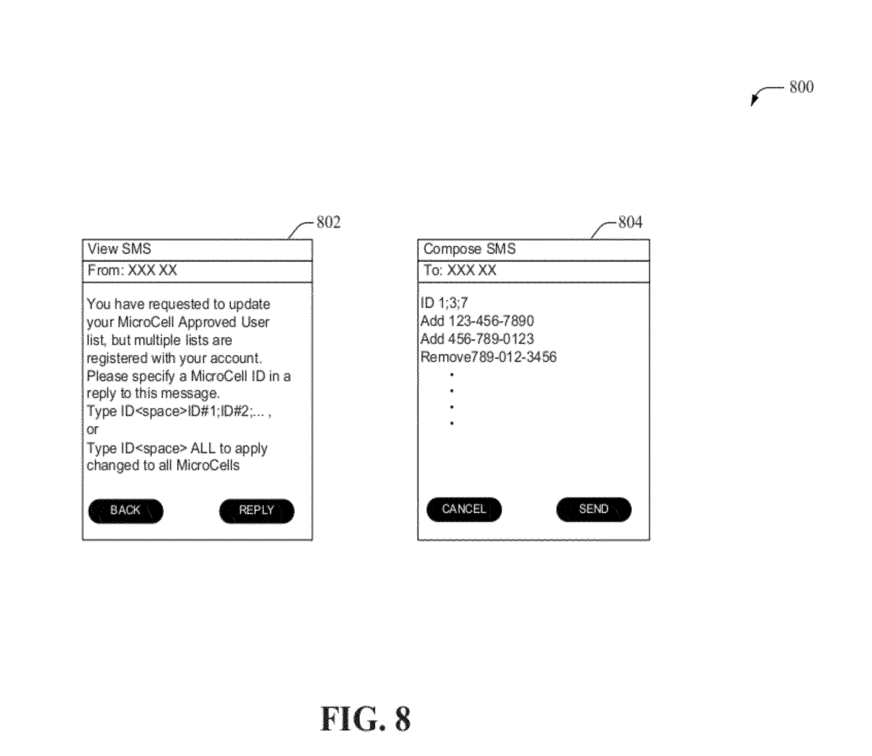

FIG. 8 illustrates example screenshots 800, which depict SMS messages employed to manage femtocell provisioning for multiple femtocells associated with a user account. In an example scenario wherein a user owns more than one femtocell, one or more femto access control lists exist for each of the femtocells. Thus, the user can specify the femtocell access list to which updates are to be made and/or contents are to be view, etc. For example, on receiving a SMS message to add/remove/view one or more entries in a femto access control list, the femtocell identification component 302 can determine the number of femtocells associated with the user/UE account (e.g., by employing a subscriber database). If no femtocells are associated with the user account, the confirmation component 306 can deliver a SMS message indicating an error to the UE. Further, if a single femtocell is associated with the account, the confirmation component 306 can deliver a SMS message to the UE, requesting confirmation for executing the requested action. Furthermore, if more than one femtocell is associated with the account, the confirmation component 306 can deliver a SMS message to the UE, requesting the user to specify the femtocell and/or femto access control list, on which the action is to be performed. For example, the user can be queried to input a unique ID(s) identifying the femtocell(s) to which changes are to be made. In another example, the user can input “ALL” to apply changes to all the femtocells associated with the user/UE account. As shown at 802, the SMS message (e.g., delivered by the confirmation component 306) can be displayed on the UE. In response to the SMS message, the user can specify femtocell IDs (e.g., 1, 3, 7, all, etc.) in most any syntax specified by the service provider, to facilitate identification of the appropriate femtocells, as shown at 804. Additionally, the update component 308 can receive the femtocell IDs and update the appropriate femto access control lists.

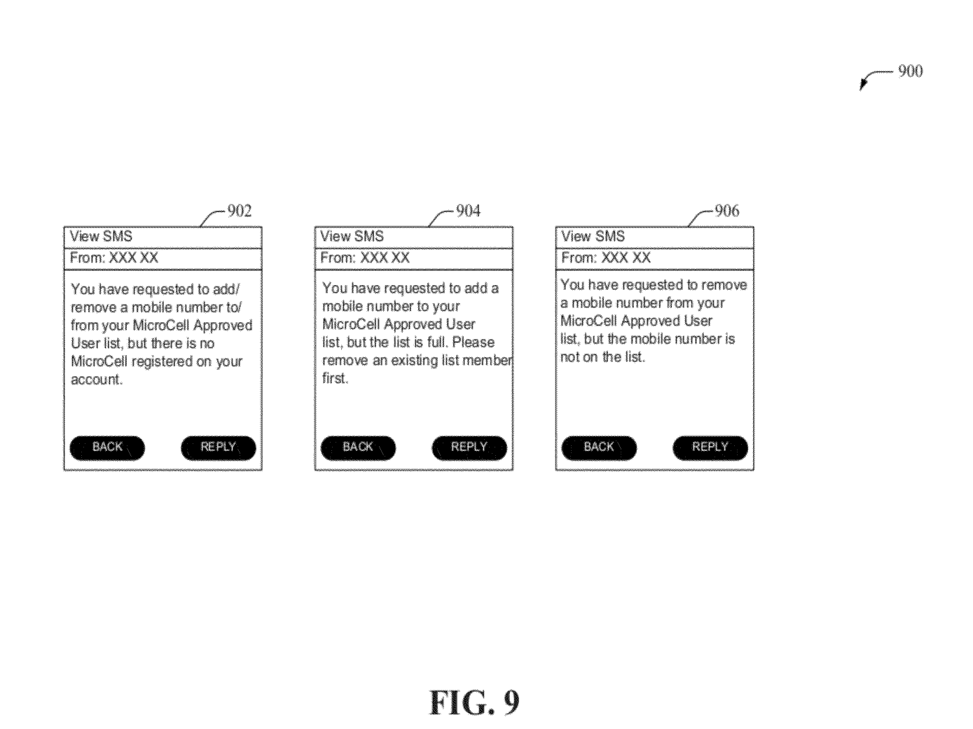

FIG. 9 illustrates example screenshots 900, which depict SMS messages delivered to a UE indicative of an error during femtocell access management, according to an aspect of the subject disclosure. In one example, a user can request to add/remove/view one or more entries of a femto cell access list by employing a SMS message. Specifically, the SMS message can be directed to a FAM component 204, which can determine a femtocell associated with a user's account. If a femtocell associated with the user account is not found, a confirmation component 306 can generate and deliver a SMS message to the UE indicating an error (e.g., “You have requested to add/remove a mobile number to/from your MicroCell Approved User list, but there is no MicroCell registered on your account.” Moreover, the SMS message can be viewed on the UE, as shown at 902.

In another example scenario, when a user sends a SMS message (e.g., 502) to grant femto access to a device, the femtocell identification component 302 detects a femtocell associated with the user and/or UE. Further, the femtocell identification component 302 determines whether the femto access control list associated with the detected femtocell is full. Specifically, if the detected femtocell is full, a new entry cannot be added unless an existing entry is removed/replaced. Hence, the confirmation component 306 can send a SMS message to the UE indicating the femtocell access list is full and/or requesting that an existing list entry be removed prior to adding the new entry. The SMS message can be viewed by the user on the UE as shown at 904.

In yet another example scenario, when a user send a SMS message (e.g., 532) to deny femto access to a device, the femtocell identification component 302 detects a femtocell associated with the user and/or UE. Further, the femtocell identification component 302 detects the entry within the femto access control list that is to be removed. If the requested information does not exist within the femto access control list, the confirmation component 306 can deliver a SMS message to the UE indicating that the requested entry is not on the femto access control list (e.g., “You have requested to remove a mobile number from your MicroCell Approved User list, but mobile number is not on the list”). The SMS message can be viewed by the user on the UE as shown at 906.

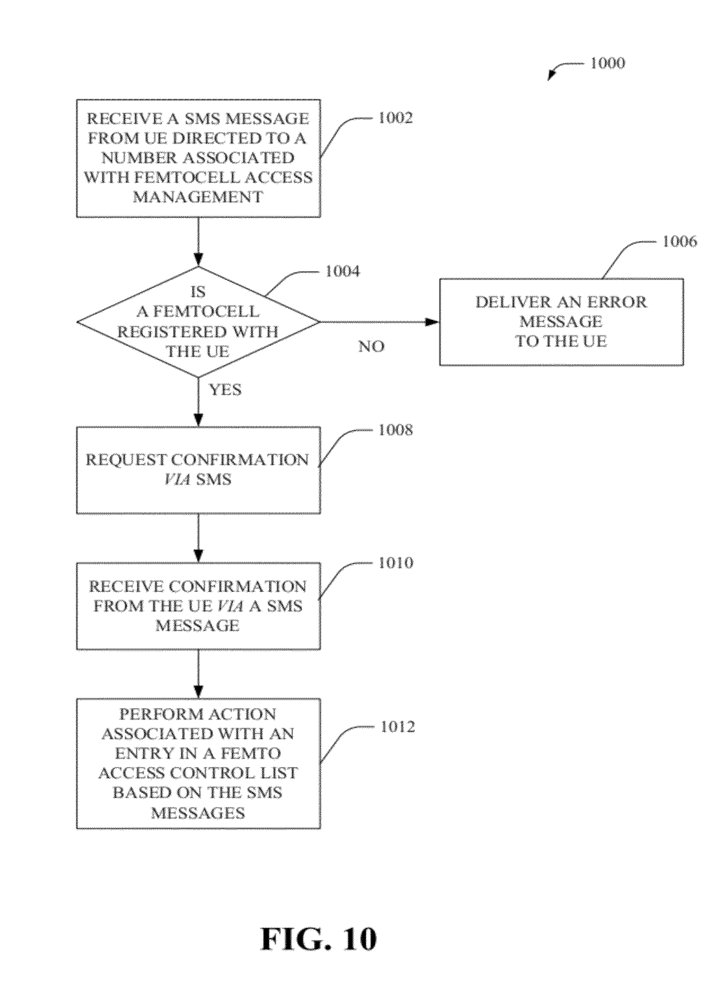

FIGS. 10-12 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or communications/storage media.

Referring now to FIG. 10, illustrated is an example methodology 1000 that can be utilized to facilitate dynamic provisioning of an access control list associated with a FAP by employing SMS communication, according to an aspect of the subject innovation. Typically, the SMS message can be sent by an authorized user from a UE connected to a macro and/or femto network. Moreover, a specific number (e.g., five-digit number, set by service provider) can be employed for femtocell access management. At 1002, a SMS message, directed to the number associated with femtocell access management, can be received from the UE. The body of the SMS message can include an action (e.g., add, remove, replace, view, etc.) to be performed on one or more entries of a femto access control list associated with the user's femtocell.

Further, at 1004, it can be determined whether a femtocell is registered with the UE (or the user). In one example, registration information associated with the UE and/or the user can be retrieved from a subscriber database within the core network. If a femtocell is not registered with the UE/user and/or cannot be found, then at 1006, an error message (e.g., “You have requested to add/remove a mobile number to/from your MicroCell Approved User list, but there is no MicroCell registered on your account”) can be delivered to the UE via SMS. Alternately, if a femtocell registered with the UE/user is found, then at 1008, a confirmation (e.g., “To confirm the action to be performed on the femto access control list, reply “1” to this message”) can be requested via a SMS message. At 1010, a confirmation can be received from the UE via a SMS message. Further, at 1012, an action (e.g., add, remove, replace, view, etc.) associated with an entry in the femto access control list can be performed based on the received SMS messages. In addition, a SMS message indicating successful completion of the requested action can be sent to the UE, on performing the action.

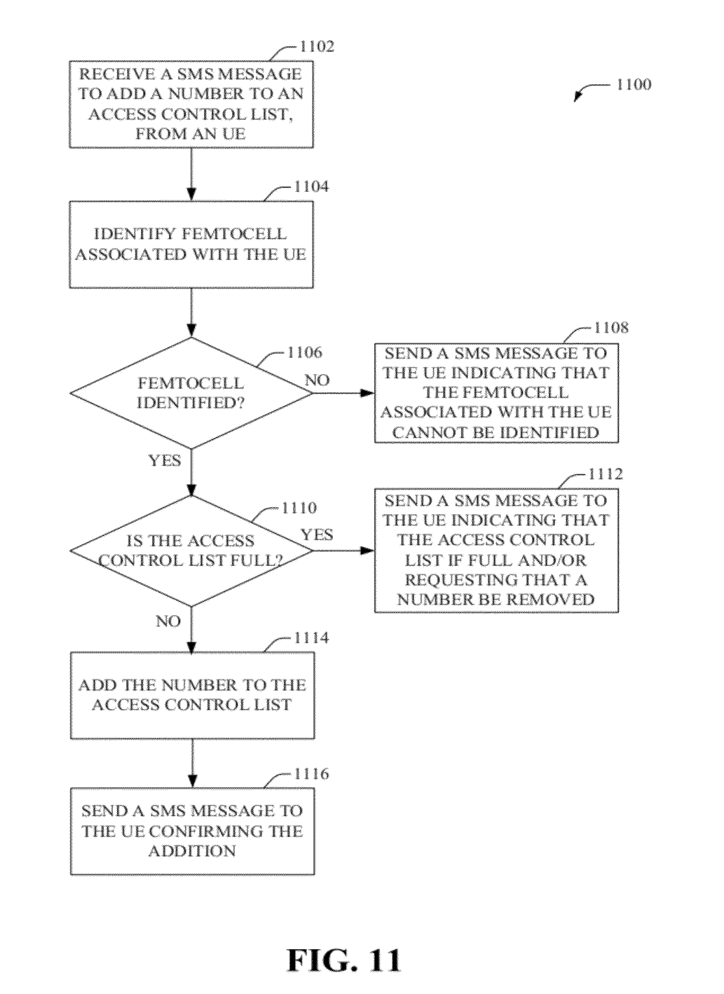

FIG. 11 illustrates an example methodology 1100 that facilitates dynamically adding a device ID to a femto access control list by employing SMS messaging, according to an aspect of the subject disclosure. Typically, a femto access control list can restrict the number of users/devices that connect to a femto network. A set of authorized users (e.g., femtocell owner) can grant femtocell access to users/devices by adding a device ID (e.g., MSISDN, IMSI, etc.), which represents the user/device, to a femto access control list associated with the femto network. The methodology 1100 enables the authorized users to dynamically create/update the access control list, from most any location, by employing SMS communication.

At 1102, a SMS message to add a number to an access control list can be received from a UE. For example, the body of the SMS message can include data in a predefined syntax (e.g., ADD<space><device ID>) and the SMS message can be directed to a specified five-digit number associated with femtocell management. Additionally or optionally, additional parameters (e.g., time period for access, type of communication granted, etc.) can also be specified within the body of the SMS message. At 1104, a femtocell associated with the UE (or user) can be identified, for example, by receiving information from a subscriber database. Further, at 1106, it can be determined whether a femtocell is identified. Moreover, if a femtocell is not identified, then at 1108, a SMS message can be sent to the UE indicating that a femtocell associated with the UE (or user) cannot be identified. Alternately, if a femtocell associated with the UE is found, at 1110, it can be determined whether an access control list associated with the femtocell is full (e.g., all entries within the list are occupied). Typically, the access control list is restricted in length (e.g., the access control list can include ten entries). Due to the length restriction of the access control list, only a limited number of UEs can be granted access to the femtocell. In an example scenario, the femtocell owner or authorized user can prefer to limit the access to the femtocell network for various factors, e.g. increase bandwidth, increase performance, increase Quality of Service and/or lower billing costs, etc.

If the access control list is full, then at 1112, a SMS message can be sent to the UE indicating that the access control list is full and/or requesting that a number be removed from the list. In contrast, if the access control list is not full, then at 1114, the requested number (e.g., MSISDN, IMSI, etc.) can be added to the list. Typically, a confirmation can be requested from the user, via SMS messages, prior to adding the number to the access control list. Further, at 1116, a SMS message can be sent to the UE confirming the addition.

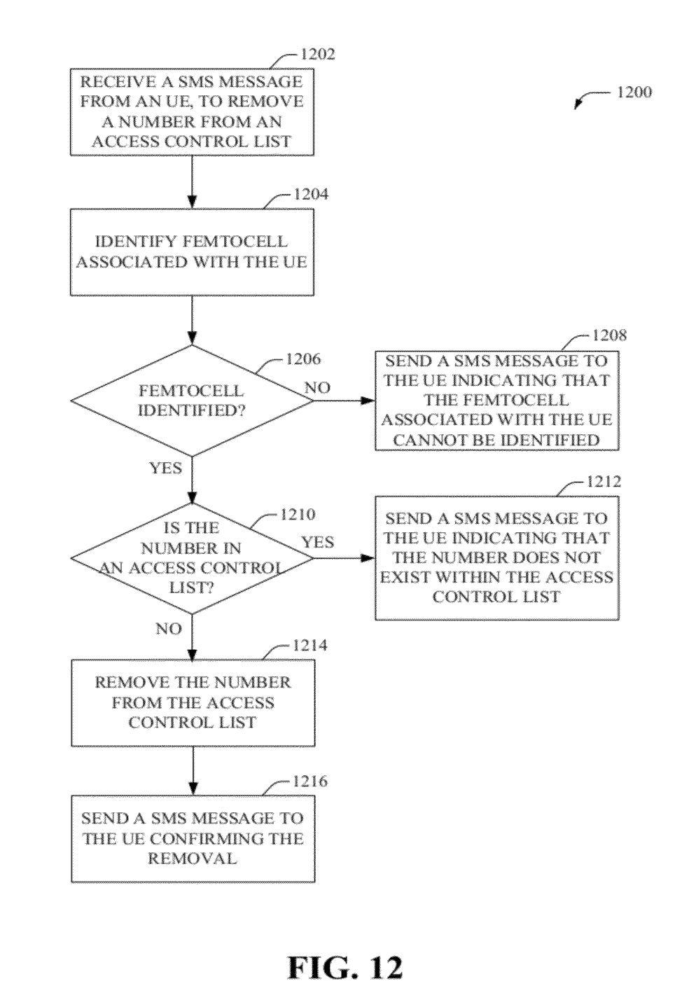

Referring now to FIG. 12, there illustrated is an example methodology 1200 for employing SMS communication to remove a number from an access control list associated with a femtocell. In general, the number of persons (e.g., friends and family) to which an authorized user (e.g., femtocell owner) can grant femtocell access is limited. Thus, the authorized user has to frequently update the access list(s) to ensure that the appropriate persons are granted access at the appropriate time. Methodology 1200 enables a user to remove a person from the access list, by transmitting SMS messages, e.g., via a macro and/or femto network.

At 1202, a SMS message can be received from a UE, to remove a number (e.g., MSISDN, IMSI, etc.) from an access control list. For example, the body of the SMS message can include an instruction in a predefined syntax (e.g., REMOVE<space><mobile number>) and the SMS message can be directed to a five-digit number associated with femtocell management. At 1206, a femtocell associated with the UE/user can be identified, for example, by employing information stored in a subscriber database in the core network. Further, at 1206, it can be determined whether a femtocell is identified. According to an aspect, if the femtocell is not identified, for example, if a femtocell is not registered with the user's account, then at 1208, a SMS message can be sent to the UE indicating that a femtocell associated with the UE (or user) cannot be identified. In contrast, if a femtocell associated with the UE is found, then, at 1210, it can be determined whether the requested number is within an access control list associated with the identified femtocell.

If the requested number is not found within the access control list, then at 1212, a SMS message can be sent to the UE indicating that the number does not exist within the access control list. Alternately, if requested number is found within the access control list, SMS messages can be exchanged with the UE to confirm the removal of the number from the access control list. Further, at 1214, the requested number (e.g., MSISDN, IMSI, etc.) can be removed from the access control list, for example, on receiving confirmation from the UE. Furthermore, at 1216, a SMS message can be sent to the UE confirming the removal of the number from the list.

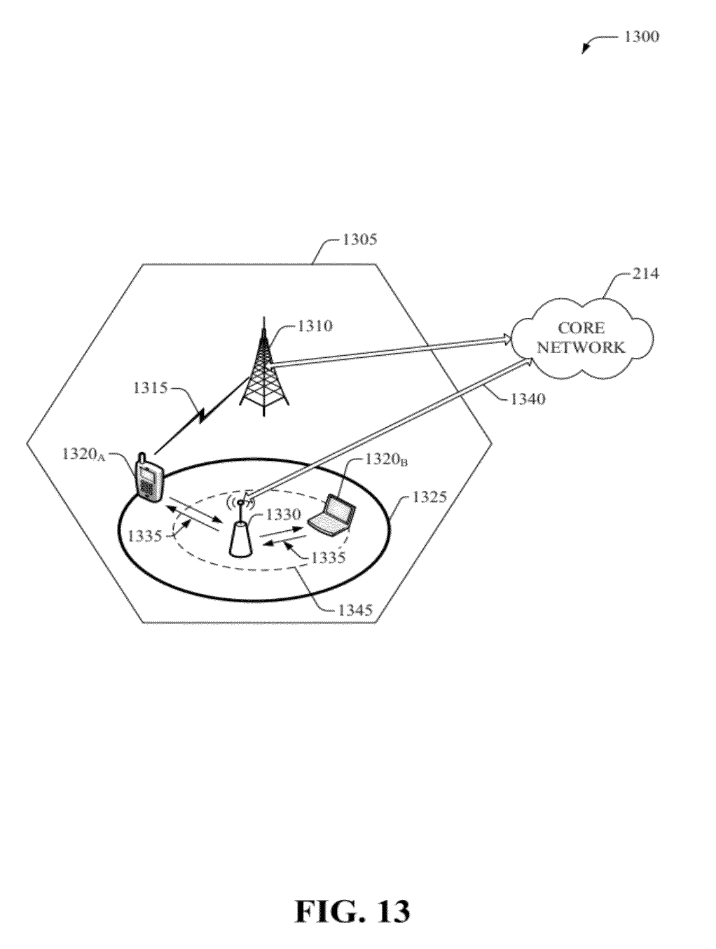

FIG. 13 illustrates a schematic wireless environment 1300 (e.g., a network) in which a femtocell can exploit various aspects of the subject innovation in accordance with the disclosed subject matter. In wireless environment 1300, area 1305 can represent a coverage macro cell, which can be served by base station 1310. Macro coverage is generally intended for outdoors locations for servicing mobile wireless devices, like UE 1320_{A}, and such coverage is achieved via a wireless link 1315. In an aspect, UE 1320 can be a 3GPP Universal Mobile Telecommunication System (UMTS) mobile phone.

Within macro coverage cell 1305, a femtocell 1345, served by a femto access point 1330, can be deployed. A femtocell typically can cover an area 1325 that is determined, at least in part, by transmission power allocated to FAP 1330, path loss, shadowing, and so forth. Coverage area typically can be spanned by a coverage radius that ranges from 20 to 50 meters. Confined coverage area 1345 is generally associated with an indoors area, or a building, which can span about 5000 sq. ft. Generally, FAP 1330 typically can service a number (e.g., a few or more) wireless devices (e.g., subscriber station 1320_{B}) within confined coverage area 1345. In an aspect, FAP 1330 can integrate seamlessly with substantially any PS-based and CS-based network; for instance, FAP 1330 can integrate into an existing 3GPP Core via conventional interfaces like Iu-CS, Iu-PS, Gi, Gn. In another aspect, FAP 1330 can exploit high-speed downlink packet access in order to accomplish substantive bitrates. In yet another aspect, FAP 1330 has a LAC (location area code) and RAC (routing area code) that can be different from the underlying macro network. These LAC and RAC are used to identify subscriber station location for a variety of reasons, most notably to direct incoming voice and data traffic to appropriate paging transmitters.

As a subscriber station, e.g., UE 1320_{A}, can leave macro coverage (e.g., cell 1305) and enters femto coverage (e.g., area 1315), as illustrated in environment 1300. According to one aspect, the FAP 1330 can grant access to the subscriber stations, by employing the femto access control list(s) (104) as described above. A carrier frequency scan can be triggered by the UE 1320_{A}, which can detect the FAP 1330. UE 1320_{A} can attempt to attach to the FAP 1330 through transmission and reception of attachment signaling, effected via a FL/RL 1335; in an aspect, the attachment signaling can include a Location Area Update (LAU) and/or Routing Area Update (RAU). Attachment attempts are a part of procedures to ensure mobility, so voice calls and sessions can continue even after a macro-to-femto transition or vice versa. It is to be noted that UE 1320 can be employed seamlessly after either of the foregoing transitions. Femto networks are also designed to serve stationary or slow-moving traffic with reduced signaling loads compared to macro networks. A femto service provider (e.g., an entity that commercializes, deploys, and/or utilizes FAP 1330) therefore can be inclined to minimize unnecessary LAU/RAU signaling activity at substantially any opportunity to do so, and through substantially any available means. It is to be noted that substantially any mitigation of unnecessary attachment signaling/control can be advantageous for femtocell operation. Conversely, if not successful, UE 1320 generally can be commanded (through a variety of communication means) to select another LAC/RAC or enter “emergency calls only” mode.

When an attachment attempt is successful, UE 1320 can be allowed on femtocell 1325 and incoming voice and data traffic can be paged and routed to the subscriber station through the FAP 1330. It is to be noted also that data traffic is typically routed through a backhaul broadband wired network backbone 1340 (e.g., optical fiber backbone, twisted-pair line, T1/E1 phone line, DSL, or coaxial cable). It is to be noted that as a FAP 1330 generally can rely on a backhaul network backbone 1340 for routing and paging, and for packet communication, substantially any quality of service can handle heterogeneous packetized traffic. Namely, packet flows established for wireless communication devices (e.g., terminals 1320_{A} and 1320_{B}) served by FAP 1330, and for devices served through the backhaul network pipe 1340. It is to be noted that to ensure a positive subscriber experience, or perception, it is desirable for FAP 1330 to maintain a high level of throughput for traffic (e.g., voice and data) utilized on a communication device for one or more subscribers while in the presence of external, additional packetized, or broadband, traffic associated with applications (e.g., web browsing, data transfer (e.g., content upload), and the like) executed in devices within the femto coverage area (e.g., area 1325 or area 1345).

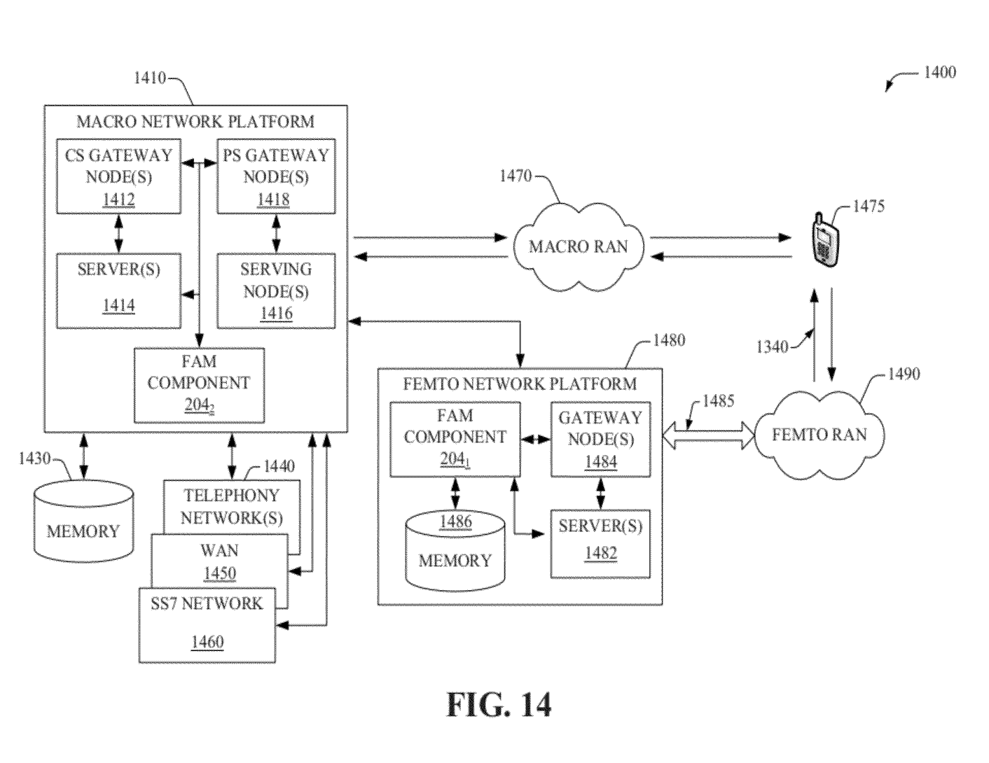

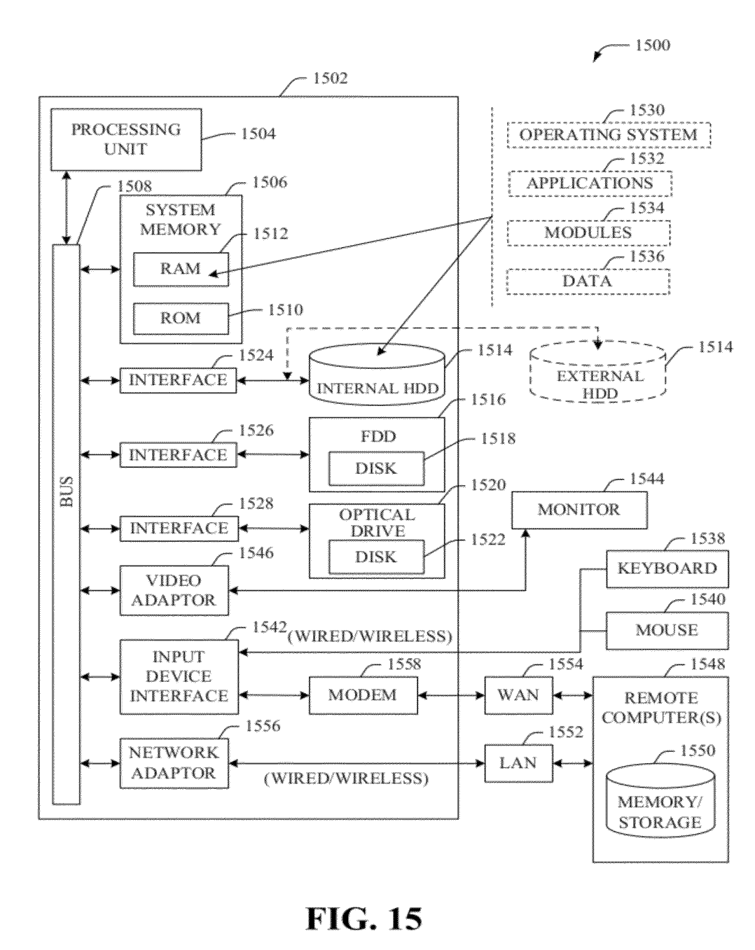

To provide further context for various aspects of the subject specification, FIGS. 14 and 15 illustrate, respectively, an example wireless communication environment 1400, with associated components for operation of a femtocell, and a block diagram of an example embodiment 1500 of a femto access point, which can facilitate dynamic femtocell access provisioning via SMS messages in accordance with aspects described herein.

Wireless communication environment 1400 includes two wireless network platforms: (i) A macro network platform 1410 that serves, or facilitates communication) with user equipment 1475 via a macro radio access network (RAN) 1470. It should be appreciated that in cellular wireless technologies (e.g., 3GPP UMTS, HSPA, 3GPP LTE, 3GPP UMB), macro network platform 1410 is embodied in a Core Network. (ii) A femto network platform 1480, which can provide communication with UE 1475 through a femto RAN 1490 linked to the femto network platform 1480 via backhaul pipe(s) 1485, wherein backhaul pipe(s) are substantially the same a backhaul link 1340. It should be appreciated that femto network platform 1480 typically offloads UE 1475 from macro network, once UE 1475 attaches (e.g., through macro-to-femto handover, or via a scan of channel resources in idle mode) to femto RAN. According to an aspect, the FAM component (204₁, 204₂), can populate an access control list, for example, stored in memory (1430, 1486), based on instructions received via SMS messages. Further, it can be appreciated that the FAM component (204₁, 204₂) can include functionality, more fully described herein, for example, with respect to systems 200, 300, and 400.

It is noted that RAN includes base station(s), or access point(s), and its associated electronic circuitry and deployment site(s), in addition to a wireless radio link operated in accordance with the base station(s). Accordingly, macro RAN 1470 can comprise various coverage cells like cell 1305, while femto RAN 1490 can comprise multiple femtocell access points. As mentioned above, it is to be appreciated that deployment density in femto RAN 1490 is substantially higher than in macro RAN 1470.

Generally, both macro and femto network platforms 1410 and 1480 can include components, e.g., nodes, gateways, interfaces, servers, or platforms, that facilitate both packet-switched (PS) and circuit-switched (CS) traffic (e.g., voice and data) and control generation for networked wireless communication. For example, macro network platform 1410 includes CS gateway node(s) 1415 which can interface CS traffic received from legacy networks like telephony network(s) 1440 (e.g., public switched telephone network (PSTN), or public land mobile network (PLMN)) or a SS7 network 1460. Moreover, CS gateway node(s) 1415 interfaces CS-based traffic and signaling and gateway node(s) 1418.

In addition to receiving and processing CS-switched traffic and signaling, gateway node(s) 1418 can authorize and authenticate PS-based data sessions with served (e.g., through macro RAN) wireless devices. Data sessions can include traffic exchange with networks external to the macro network platform 1410, like wide area network(s) (WANs) 1450; it should be appreciated that local area network(s) (LANs) can also be interfaced with macro network platform 1410 through gateway node(s) 1418. Gateway node(s) 1418 generates packet data contexts when a data session is established. It should be further appreciated that the packetized communication can include multiple flows that can be generated through server(s) 1414. Macro network platform 1410 also includes serving node(s) 1416 that convey the various packetized flows of information, or data streams, received through gateway node(s) 1418. It is to be noted that server(s) 1414 can include one or more processor configured to confer at least in part the functionality of macro network platform 1410. To that end, the one or more processor can execute code instructions stored in memory 1430, for example.

In example wireless environment 1400, memory 1430 stores information related to operation of macro network platform 1410. Information can include business data associated with subscribers; market plans and strategies, e.g., promotional campaigns, business partnerships; operational data for mobile devices served through macro network platform; service and privacy policies; end-user service logs for law enforcement; and so forth. Memory 1430 can also store information from at least one of telephony network(s) 1440, WAN(s) 1450, or SS7 network 1460.

Femto gateway node(s) 1484 have substantially the same functionality as PS gateway node(s) 1418. Additionally, femto gateway node(s) 1484 can also include substantially all functionality of serving node(s) 1416. In an aspect, femto gateway node(s) 1484 facilitates handover resolution, e.g., assessment and execution. Server(s) 1482 have substantially the same functionality as described in connection with server(s) 1414 and can include one or more processor configured to confer at least in part the functionality of macro network platform 1410. To that end, the one or more processor can execute code instructions stored in memory 1486, for example.

Memory 1486 can include information relevant to operation of the various components of femto network platform 1480. For example operational information that can be stored in memory 1486 can comprise, but is not limited to, subscriber information; contracted services; maintenance and service records; femtocell configuration (e.g., devices served through femto RAN 1490; access control lists, or white lists); service policies and specifications; privacy policies; add-on features; and so forth.

Referring now to FIG. 15, there is illustrated a block diagram of a computer operable to execute the disclosed communication architecture. In order to provide additional context for various aspects of the subject specification, FIG. 15 and the following discussion are intended to provide a brief, general description of a suitable computing environment 1500 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various aspects of the specification includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 can also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies. Other external drive connection technologies are within contemplation of the subject specification.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to a HDD, a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is appreciated that the specification can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) can include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 can operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 is connected to the local network 1552 through a wired and/or wireless communication network interface or adapter 1556. The adapter 1556 can facilitate wired or wireless communication to the LAN 1552, which can also include a wireless access point disposed thereon for communicating with the wireless adapter 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are example and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates dynamic femtocell access provisioning, comprising:
a femto access management (FAM) component that receives at least one instruction, to perform an action associated with the femtocell access provisioning, embodied within a first Short Message Service (SMS) message; and
an update component that dynamically executes the at least one instruction to perform the action.

2. The system of claim 1, wherein the action includes at least one of adding, removing or viewing at least one entry to a femtocell access control list.

3. The system of claim 1, further comprising, a femtocell identification component that detects a femtocell associated with at least one of a user or a user equipment (UE), which sends the SMS message.

4. The system of claim 3, wherein the femtocell identification component retrieves data related to the user's account from a subscriber database within a core network.

5. The system of claim 3, wherein the femtocell identification component facilitates selection of a set of femtocells, if a plurality of femtocells associated with at least one of the user or the UE are identified.

6. The system of claim 1, further comprising, a confirmation component that generates an auto-reply in response to the first SMS message to request confirmation for execution of the at least one instruction.

7. The system of claim 6, wherein the confirmation component transmits the auto-reply, via a second SMS message, to a user equipment (UE), which provides the at least one instruction.

8. The system of claim 6, wherein the confirmation component determines an error during execution of the at least one instruction and transmits a third SMS message indicative of the error.

9. The system of claim 6, wherein the confirmation component delivers a fourth SMS message to a user equipment (UE), which provides the at least one instruction, the fourth SMS message indicates successful execution of the at least one instruction.

10. The system of claim 1, further comprising a security component that facilitates at least one of authentication or authorization of at least one of a user equipment (UE) or a user that sends the SMS message.

11. A method that facilitates dynamically managing a femto access control list associated with a femto access point (FAP), comprising:
receiving a Short Message Service (SMS) message from a user equipment (UE);
performing an action associated with the femto access control list based in part on at least one computer-readable instruction embodied within the SMS message.

12. The method of claim 11, further comprising, determining whether a femtocell is registered with the UE.

13. The method of claim 12, further comprising, delivering an error message to the UE via SMS communication, if the femtocell is not registered with the UE.

14. The method of claim 11, further comprising, transmitting an auto-reply SMS message to the UE that requests a confirmation for performing the action.

15. The method of claim 14, further comprising, receiving a disparate SMS message from the UE, in response to the auto-reply SMS message, providing the confirmation.

16. The method of claim 15, wherein the performing the action includes performing the action associated with the femto access control list, if the confirmation is received.

17. The method of claim 11, wherein the performing the action includes at least one of adding a requested entry to the femto access control list, removing a disparate requested entry from the femto access control list, transmitting the femto access control list to the UE via SMS communication.

18. A system that enables dynamic femto access provisioning, via Short Message Service (SMS) messaging, comprising:
means for receiving a SMS message that includes an instruction related to at least one entry within a femto access control list; and
means for at least one of creating, deleting, modifying or updating the at least one entry based on an analysis of the SMS message.

19. The system of claim 18, further comprising, means for identifying the femto access control list associated with a sender of the SMS message.

20. The system of claim 18, further comprising, means for providing a disparate SMS message to a sender of the SMS message, wherein the disparate SMS message includes at least one of a first message indicating an error during execution of the instruction, a second message requesting confirmation to execute the instruction, or a third message indicating that the instruction has been successfully performed.
